(19) United States
(12) Patent Application Publication
(10) Pub. No.: US 2013/0283626 A1
(43) Pub. Date: Oct. 31, 2013

(54) MEASURING TOOL

(71) Applicant: Michael D. Jones, Auckland (NZ)

(72) Inventor: Michael D. Jones, Auckland (NZ)

(21) Appl. No.: 13/876,454

(22) PCT Filed: Aug. 2, 2011
(86) PCT No.: PCT/NZ2011/000148

§ 371 Date: Jun. 6, 2013

(30) Foreign Application Priority Data
Sep. 28, 2010 (NZ) 588226

(51) Int. Cl. G01B 5/24

(52) U.S. Cl. CPC G01B 5/24
USPC 33/418

(57) ABSTRACT

A measuring tool which has a first arm and a second arm where at least one of the arms is able to pivot so that the arms can be set at a variety of angles with respect to one another. The tool also has an angle scale and a pointer. The angle scale runs along the first arm and the pointer is able to pivot so that it can point to a variety of positions along the angle scale to give the angle between the arms, the pointer being arranged such that it can be swung away from and clear of the angle scale.

### CROSS-REFERENCE TO RELATED APPLICATIONS

This application is the national phase under 35 U.S.C. §371 of PCT International Application No. PCT/NZ2011/000148, filed Aug. 2, 2011, which claims the benefit of New Zealand Patent Application No. 588226 filed Sep. 28, 2010, the entire contents of the aforementioned applications are hereby incorporated herein by reference.

### FIELD OF INVENTION

This invention relates to a tool suitable for use in measuring angles.

### BACKGROUND

In the field of construction it is known to use a bevel tool to measure the angle between intersecting surfaces, for example two walls which merge into one another. Some bevels have two arms which can swing about a common pivot point. The arms are opened up, one is placed against one wall and the other against another wall. The angle between the arms thus reproduces the angle between the walls. By subsequently laying the arms against a protractor the exact angle of the arms and thus the wall is measured. However this can be less than optimal because it involves the use of a second tool, namely the protractor. It is accordingly an object of a preferred form of the present invention to go at least some way towards providing a useful alternative.

### SUMMARY OF THE INVENTION

According to one aspect of the invention there is provided a measuring tool which has a first arm and a second arm, at least one of the arms is able to pivot so that the arms can be set at a variety of angles with respect to one another, the tool also has an angle scale and a pointer, the angle scale runs along the first arm and the pointer is able to pivot so that it can point to a variety of positions along the angle scale to give the angle between the arms, the pointer being arranged such that it can be swung away from and clear of the angle scale.

Optionally the pointer pivots from a location part way along the second arm.

Optionally the first arm has a groove extending along the angle scale and one end of the pointer can run along the groove so that such end is substantially retained against the angle scale but can be subsequently released.

Optionally the pointer has a raised part adapted to fit snugly in and run along the groove.

Optionally at least one of the arms has a ruler scale so that it can function as a ruler.

Optionally each arm has a ruler scale so that it can function as a ruler.

Optionally the tool has a locking mechanism which can be used to releasably lock the angle between the arms.

Optionally the first arm has locking recesses at 45° and 90° along the angle scale to facilitate retention of the pointer if it indicates either of these as the angle between the arms.

Optionally the pointer can be swung away from the first arm and laid against the second arm.

Optionally the first and second arms can be set at an angle of between approximately 0° and approximately 180° with respect to one another.

Optionally each of the arms can fold back on itself to enable the tool to be stowed in a compact manner.

Optionally the measuring tool incorporates a spirit level in one of the arms.

Optionally the spirit level is able to be rotated with respect to the rest of the tool.

### BRIEF DESCRIPTION OF THE DRAWINGS

Some preferred forms of the invention with now be described by way of example and with reference to the accompanying drawings, of which:

FIG. 1 is an isometric view of a bevel tool with its arms set at a first angle;

FIGS. 2-5 illustrate the tool when the arms are at various other angles; and

FIG. 6 illustrates of a bevel tool incorporating a spirit level.

### DETAILED DESCRIPTION

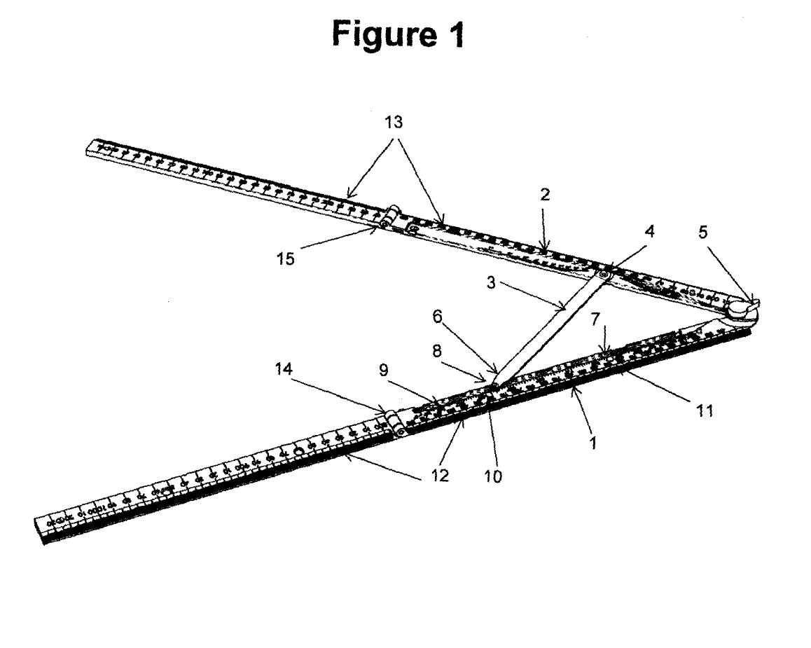

Referring to FIG. 1, the bevel tool has a first arm 1, a second arm 2 and a pointer 3. The pointer 3 is fixed to and swings about a pivot point 4 on the second arm. A locking nut 5 can be turned one way to fix the angle between the two arms, and then turned the other way enable the arms to pivot. The distill end of the pointer has an arrowhead 6 which can be swung to contact various positions along the first arm 1. The first arm has an angle scale 7 running along its inside edge. The position along the scale 7 that the pointer touches marks the angle between the two arms 1, 2 at any one time. The angle between the arms can thus be read without having to lay them against a protractor.

The arrowhead 6 of the pointer has a small mound 8 which can be pressed into a slot 9 running along the angle scale. This helps to stiffen movement of the pointer along the scale so that it cannot too easily pivot away from the scale, for example under the force of gravity, when one is reading the current angle.

The first arm has a series of small recesses, for example holes, set along the scale at the position of standard angles. For example a first hole 10 is located at the 45° position and a second hole 11 is located at the 90° position. The mound 8 at the end of the arrowhead can be pressed into either of these holes to hold the arms 1, 2 at 45° or 90° respectively. In other embodiments of the invention similar holes may be located for other angles commonly used in the context of building.

The arms 1, 2 each have a ruler scale 12, 13 to that they can be used as rulers. Further, they each have a hinge 14, 15 to enable them to fold back on themselves so that the tool can be stowed in a compact fashion, for example in a carpenters tool belt.

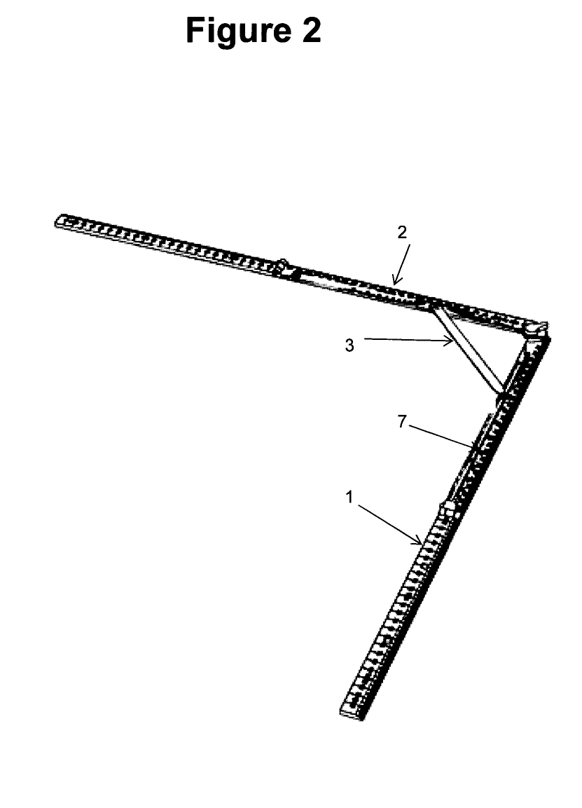

FIG. 2 shows the tool when the arms are set at right angles with the pointer 3 pointing to 90° on the angle scale 7.

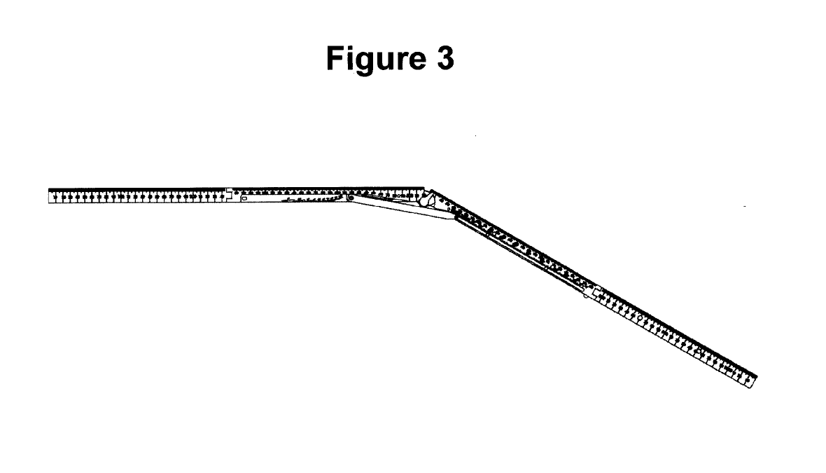

FIG. 3 shows the tool when the arms are at an angle of slightly less than 180°. In the embodiment shown, this is the maximum angle possible with the pointer in use, pointing to the angle scale, in view of the position of the nut 5.

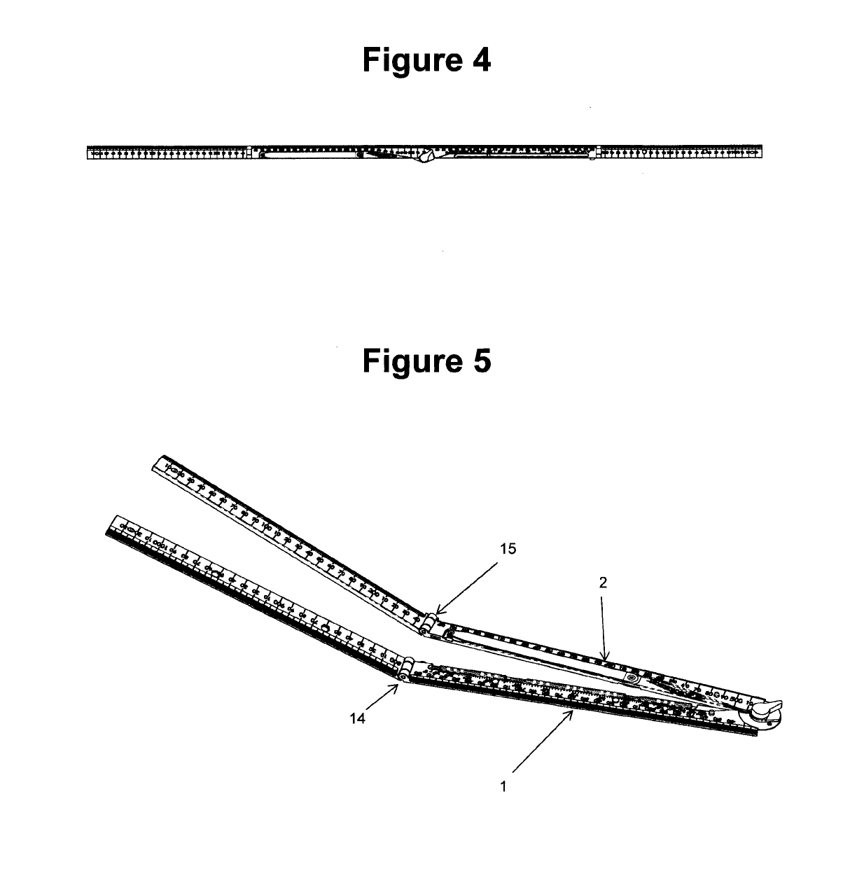

FIG. 4 shows the tool when the arms are fully opened out at an angle of 180°. In this case the pointer 3 lies against the second arm 2 and does not point to the angle scale 7.

FIG. 5 shows the tool with the pointer 3 indicating an acute angle. It also illustrates the arms 1, 2 when party folded about the hinges 14, 15.

When the bevel tool is used to measure the angle between walls the edge of one of the arms is laid against one of the walls. The nut 5 is loosened and the other arm is swung until it lays against the other wall. The pointer 3 is swung about its pivot point 4 until its arrowhead 7 is within the slot 9 touching the angle scale 7. The number indicated at the point the arrowhead 6 touches the scale gives the angle between the walls. The bevel tool can of course be used to measure the angle between other objects in a similar fashion if required.

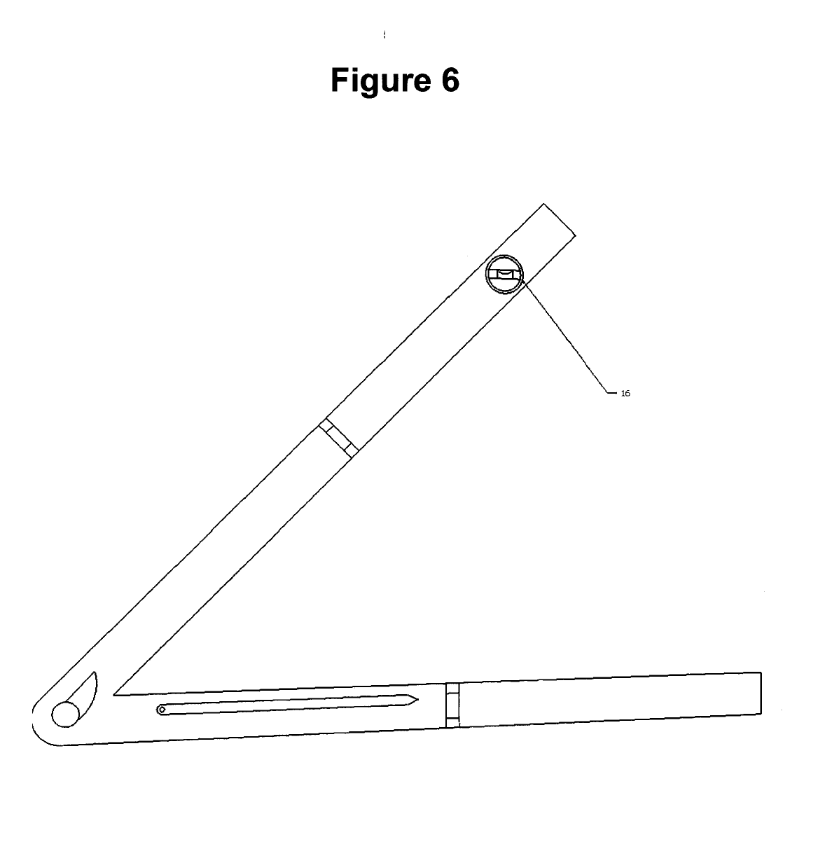

Referring to FIG. 6, in a further embodiment of the invention the bevel tool may be formed essentially the same as described above, except that it includes a spirit level 16 at the outer end of the first arm. This is particularly useful when the two arms are angled from one another in a vertical plane rather than a horizontal one. The spirit level is able to rotate within the first arm so that it can be set to horizontal, or various other angles, regardless of the actual angle of first arm. The spirit level thus provides useful further aspect to the tool. In some embodiments the bevel tool may have two spirit levels fixed to operate at 90° with respect to one another.

While some preferred forms of the invention have been described by way of example it should be appreciated that modifications and improvements can occur without departing from the scope of the following claims.

1. A measuring tool which has a first arm and a second arm, at least one of the arms is able to pivot so that the arms can be set at a variety of angles with respect to one another, the tool also has an angle scale and a pointer, the angle scale runs along the first arm and the pointer is able to pivot so that it can point to a variety of positions along the angle scale to give the angle between the arms, the pointer being arranged such that it can be swung away from and clear of the angle scale.

2. (canceled)

3. A measuring tool according to claim 1, wherein the first arm has a groove extending along the angle scale and one end of the pointer can run along the groove so that such end is substantially retained against the angle scale but can be subsequently released.

4. A measuring tool according to claim 1, wherein the pointer pivots from a location part way along the second arm and has a raised part adapted to fit snugly in and run along the groove.

5. A measuring tool according to claim 1, wherein at least one or each of the arms has a ruler scale so that it can function as a ruler and wherein each of the arms can fold back on itself to enable the tool to be stowed in a compact manner.

6. (canceled)

7. A measuring tool according to claim 1, having a locking mechanism which can be used to releasably lock the angle between the arms.

8. A measuring tool according to claim 1, wherein the first arm has locking recesses at 45° and 90° along the angle scale to facilitate retention of the pointer if it indicates either of these as the angle between the arms.

9. (canceled)

10. A measuring tool according to claim 1, wherein the first and second arms can be set at an angle of between approximately 0° and approximately 180° with respect to one another.

11. (canceled)

12. A measuring tool according to claim 1, incorporating a spirit level in one of the arms wherein the spirit level is able to be rotated with respect to the rest of the tool.

13. (canceled)

14. (canceled)

15. A measuring tool which has a first arm and a second arm, at least one of the arms is able to pivot so that the arms can be set at a variety of angles with respect to one another, the tool also has an angle scale and a pointer, the angle scale runs along the first arm and the pointer is able to pivot so that it can point to a variety of positions along the angle scale to give the angle between the arms, the pointer being arranged such that it can be swung away from and clear of the angle scale;
wherein the first arm has a groove extending along the angle scale and one end of the pointer can run along the groove so that such end is substantially retained against the angle scale but can be subsequently released, and the first arm has locking recesses at 45° and 90° along the angle scale to facilitate retention of the pointer if it indicates either of these as the angle between the arms;
wherein the pointer pivots from a location part way along the second arm and has a raised part adapted to fit snugly in and run along the groove;
wherein at least one or each of the arms has a ruler scale so that it can function as a ruler and wherein each of the arms can fold back on itself to enable the tool to be stowed in a compact manner;
wherein the tool has a locking mechanism which can be used to releasably lock the angle between the arms and the tool incorporates a spirit level in one of the arms, the spirit level able to be rotated with respect to the rest of the tool; and
wherein the first and second arms can be set at an angle of between approximately 0° and approximately 180° with respect to one another.

16. A measuring tool according to claim 3, wherein the pointer pivots from a location part way along the second arm and has a raised part adapted to fit snugly in and run along the groove.

17. A measuring tool according to claim 3, wherein at least one or each of the arms has a ruler scale so that it can function as a ruler and wherein each of the arms can fold back on itself to enable the tool to be stowed in a compact manner.

18. A measuring tool according to claim 4, wherein at least one or each of the arms has a ruler scale so that it can function as a ruler and wherein each of the arms can fold back on itself to enable the tool to be stowed in a compact manner

19. A measuring tool according to claim 1, having a locking mechanism which can be used to releasably lock the angle between the arms; wherein the first arm has a groove extending along the angle scale and one end of the pointer can run along the groove so that such end is substantially retained against the angle scale but can be subsequently released; wherein the pointer pivots from a location part way along the second arm and has a raised part adapted to fit snugly in and run along the groove; and wherein at least one or each of the arms has a ruler scale so that it can function as a ruler and wherein each of the arms can fold back on itself to enable the tool to be stowed in a compact manner.

20. A measuring tool according to claim 1, wherein the first arm has locking recesses at 45° and 90° along the angle scale to facilitate retention of the pointer if it indicates either of these as the angle between the arms; wherein the first arm has a groove extending along the angle scale and one end of the pointer can run along the groove so that such end is substantially retained against the angle scale but can be subsequently released; wherein the pointer pivots from a location part way along the second arm and has a raised part adapted to fit snugly in and run along the groove; and wherein at least one or each of the arms has a ruler scale so that it can function as a ruler and wherein each of the arms can fold back on itself to enable the tool to be stowed in a compact manner.

21. A measuring tool according to claim 1, having a locking mechanism which can be used to releasably lock the angle between the arms; wherein the first arm has a groove extending along the angle scale and one end of the pointer can run along the groove so that such end is substantially retained against the angle scale but can be subsequently released; and wherein the pointer pivots from a location part way along the second arm and has a raised part adapted to fit snugly in and run along the groove.

22. A measuring tool according to claim 1, wherein the first arm has locking recesses at 45° and 90° along the angle scale to facilitate retention of the pointer if it indicates either of these as the angle between the arms; wherein the first arm has a groove extending along the angle scale and one end of the pointer can run along the groove so that such end is substantially retained against the angle scale but can be subsequently released; and wherein the pointer pivots from a location part way along the second arm and has a raised part adapted to fit snugly in and run along the groove.

23. A measuring tool according to claim 3, having a locking mechanism which can be used to releasably lock the angle between the arms.

24. A measuring tool according to claim 3, wherein the first arm has locking recesses at 45° and 90° along the angle scale to facilitate retention of the pointer if it indicates either of these as the angle between the arms.

25. A measuring tool according to claim 4, having a locking mechanism which can be used to releasably lock the angle between the arms.

26. A measuring tool according to claim 4, wherein the first arm has locking recesses at 45° and 90° along the angle scale to facilitate retention of the pointer if it indicates either of these as the angle between the arms.
